(19) United States
(12) Patent Application Publication
(10) Pub. No.: US 2016/0207476 A1
(43) Pub. Date: Jul. 21, 2016

(54) COMPONENT FOR A MOTOR VEHICLE CONSISTING OF A PLASTIC PART AND A HEAT SHIELD

(71) Applicant: GM GLOBAL TECHNOLOGY OPERATIONS LLC, Detroit, MI (US)

(72) Inventor: Peter Scholz, Mainz-Kastel (DE)

(73) Assignee: GM GLOBAL TECHNOLOGY OPERATIONS LLC, Detroit, MI (US)

(21) Appl. No.: 14/995,591

(22) Filed: Jan. 14, 2016

(30) Foreign Application Priority Data
Jan. 17, 2015 (DE) 202015000342.7

(51) Int. Cl. B60R 13/08; F02B 77/02

(52) U.S. Cl. CPC B60R 13/08; B60R 13/0838; F02B 77/02

(57) ABSTRACT

A component for a motor vehicle includes a plastic part to which a heat shield is fastened. A projection extends into a hole in the heat shield and is reshaped to form a rivet connection having a rivet heat that hooks with the heat shield. A protruding attachment is provided on the rivet head for fastening a covering element.

### CROSS-REFERENCE TO RELATED APPLICATION

This application claims priority to German Patent Application No. 202015000342.7, filed Jan. 17, 2015, which is incorporated herein by reference in its entirety.

### TECHNICAL FIELD

The present disclosure pertains to components for a motor vehicle having a plastic part to which a heat shield is fastened.

### BACKGROUND

Components having a plastic part and a heat shield fastened to the plastic part are being used in motor vehicles more and more often in normal car manufacturing practices. The heat shield is intended to protect the plastic part from damage due to the generation of strong heat close to the component, if the component is arranged inside the engine compartment of a motor vehicle, for example. Thus, the plastic part may for example be a valve cover, a camshaft cover or the like. In order to fasten the heat shield to the plastic part, the plastic part has a projection that extends into a hole in the heat shield. The projection is reshaped forming a rivet joint with a rivet heat that hooks behind the heat shield.

When the motor vehicle is operated with such a component, it has been found that the protection for the plastic part against the damaging effects of heat is inadequate with the known components, and the heat shield is not sufficiently well attached to the plastic part.

### SUMMARY

The provides a species-related component for a motor vehicle with which the plastic part can be protected reliably from the damaging effects of heat such that adequate attachment of the heat shield to the plastic part is provided.

One embodiment of the present disclosure relates to a component for a motor vehicle including a plastic part to which a heat shield is fastened. The plastic part has a projection that extends into a hole in the heat shield, which projection is preferably constructed integrally with the plastic part and can be produced together with the plastic part during an injection molding process, for example. The projection is reshaped, forming a rivet joint with a rivet head that hooks behind the heat shield, wherein this has preferably been carried out using a molded part to mold the rivet head and with the effect of heat. A protruding attachment is also provided on the rivet head for the purpose of attaching a covering element. In other words, the protruding attachment provided on the rivet head generally enables a covering element to be attached, which protects the plastic part, more precisely the rivet head and the protruding attachment on the rivet head, from the damaging effect of heat. Thus, if a covering element is fastened to the protruding attachment, both the plastic part and the rivet head thereof as well as the protruding attachment may be protected from the damaging effect of heat, so that on the one hand the plastic part is better protected. On the other hand, a reliable attachment of the heat shield to the plastic part is provided, since the rivet head, and thus the fastening point between the heat shield and the plastic part, is also protected from the damaging effect of heat. Even if such a covering element is not used, the protruding attachment at least offers the possibility of fastening such a covering element to the protruding attachment simply, so the product can even be retrofitted if necessary.

In a preferred embodiment of the component according to the present disclosure, the aforementioned covering element to protect the rivet head and thus also to protect the fastening point of the heat shield is provided on the plastic part, and is fastened or fastenable to the protruding attachment. Regarding the advantages of this embodiment, reference is made to the advantages of such a covering element as outlined in the preceding text.

In an advantageous embodiment of the component according to the present disclosure, the covering element can be fastened to the protruding attachment in positive and/or force-fitting manner to guarantee simple, reliable assembly.

For example, the covering element might be designed so that it can be screwed onto the protruding attachment, for example, since the covering element itself is preferably not intended to be used to fasten the heat shield to the plastic part, and instead only cover the rivet head and possibly the protruding attachment as well, but still other design variants are preferred, as will be explained in the following.

For example, in an advantageous variant of the component according to the present disclosure, the covering element can be joined to the protruding attachment, preferably creating a positive and/or force-fitting connection. Accordingly, a simple translatory movement of the covering element to the reference position thereof on the protruding attachment is all that is required to guarantee that the rivet head and possibly the protruding attachment as well, is/are covered, which significantly simplifies assembly. In this context, the covering element may be insertable in a hole on the protruding attachment for example, but it is preferable if the covering element can be mounted on the protruding attachment, since this simplifies the reshaping of the projection on the plastic part to create the rivet head and the protruding attachment.

In a further preferred embodiment of the component according to the present disclosure, the covering element has a fastening section with which it can be fastened to the protruding attachment and a covering section for covering the rivet head. In this embodiment, it is preferable if the rivet head—when viewed in the extension direction of the protruding attachment—is or can be completely covered by the covering section, in order to ensure corresponding protection for the rivet head from the damaging effect of heat. In this embodiment it is preferable if the protruding attachment—when viewed in the extension direction of the protruding attachment is additionally or alternatively completely coverable or covered by the fastening section of the covering element, so that the protruding attachment might also be protected from the damaging effect of heat, as this would ultimately also affect the rivet head.

In order not only to protect the rivet head reliably from the damaging effect of heat but also to guarantee that the covering element is fastened securely to the protruding attachment, as well as providing reliable protection for the protruding attachment itself against heat-related damage, in a particularly preferred embodiment of the component according to the present disclosure the fastening section of the covering element has the shape of a cup. In this context, it is preferable if the protruding attachment can be or is accommodated in the cup-shaped fastening section.

In order to provide a secure covering or screen for the rivet head, in a further advantageous embodiment of the component according to the present disclosure the covering section of the covering element is substantially disc-shaped, preferably annular. Alternatively or in addition thereto, the covering section surrounds the fastening section, in which case it is preferable of the covering section entirely surrounds and encloses the fastening section. Thus for example, the covering section may surround and preferably enclose the opening of the cup-shaped fastening section, but it is also possible for the covering section to surround and preferably enclose a cup-shaped fastening section elsewhere, for example in the bottom of the cup-shaped fastening section.

According to a further preferred embodiment of the component according to the present disclosure, the fastening section includes at least one fastening projection, by means of which the fastening section is fastenable or fastened to the protruding attachment. In this context, the at least one fastening projection preferably is or can be connected to the protruding attachment while preserving a distance from the rest of the fastening section. The fastening section may be for example a fastening projection that indents and/or cuts into the protruding attachment to achieve a secure fastening. Alternatively or in addition thereto, the fastening section may also be a fastening projection that is or can be preloaded against a prominent attachment to realize a secure fastening of the fastening section against the prominent attachment. A fastening section that is or can be preloaded against a prominent attachment in this manner may be constructed for example from an optionally elastic support tab, which may be produced for example from a part of the fastening section, by punching out the support tab, for example.

In a further advantageous embodiment of the component according to the present disclosure, the covering element is or may be fastened to the protruding attachment while preserving a distance between said element and the rivet head. In this context, it is preferable if the covering element is or may be fastened to the protruding attachment while preserving a distance between the covering section of the covering element and the rivet head. In this way, particularly secure protection of the rivet head from the damaging effect of heat is achieved, regardless of the respective design variant.

According to a further advantageous embodiment of the component according to the present disclosure, the protruding attachment is arranged on the side of the rivet head that faces away from a section of the projection that extends through the hole, in order to create a particularly easily producible protruding attachment, which is also relatively easily accessible, to enable the covering element to be fitted on it, for example. In this embodiment, it is preferable if the protruding attachment is arranged to lie flush with the section of the projection that extends through the hole in the direction of extension of this section. In this context, it also proven advantageous if the section of the projection that extends through the hole and the protruding attachment have the same extension direction, that is to say they are disposed in a common linear extension.

In order to guarantee both a secure fastening of the heat shield with the plastic part and a simple, secure fastening of the covering element to the protruding attachment, in another preferred embodiment of the component according to the present disclosure the protruding attachment has a smaller cross sectional area and/or cross sectional width and/or cross sectional height than the rivet head. In this context, it is particularly preferable if the cross section width and the cross section height of the protruding attachment, and therewith also the cross section area thereof, are smaller than the cross section width and the cross section height of the protruding attachment, and therewith also the cross section area of the rivet head.

In order to be able to fit the covering element easily on the protruding attachment, in a further preferred embodiment of the component according to the present disclosure the protruding attachment has a uniform cross section area, cross section shape, cross section width and/or cross section height in at least one extension segment thereof. In a preferred embodiment, this may apply not only for one extension segment, but also for the entire extension length.

According to a further advantageous embodiment of the component according to the present disclosure, the cross section of the protruding attachment is circular or polygonal, that is to say example triangular or rectangular. With a circular cross section, it is also possible to consider a cylindrical protruding attachment or section thereof.

In a further advantageous embodiment of the component according to the present disclosure, not only the rivet head but the protruding attachment as well is produced by reshaping the projection on the plastic part.

In a further, particularly preferred embodiment of the component according to the present disclosure, the heat shield and/or the covering element have greater thermal resistance and/or thermal conductivity than the plastic part. Greater thermal resistance is particularly advantageous here, in order to be able to protect the plastic part as necessary from the damaging effect of heat. On the other hand, greater thermal conductivity of the heat shield and/or the covering element is of advantage if the heat shield is able to deliver the heat to other components or the outside atmosphere if the heat shield is connected to other components, for example, or equipped with a cooling apparatus such as cooling fins.

In principle, the heat shield and/or the covering element might also be made from plastic, provided such plastic has greater thermal resistance and/or thermal conductivity than the plastic of the plastic part. In a preferred embodiment of the component according to the present disclosure, however, the heat shield and/or the covering element is/are made from a metal, optionally steel or aluminum, to guarantee particularly secure protection of the plastic part and/or the rivet joint.

In principle, the heat shield and/or the covering element might also be made from different materials, but in a further advantageous embodiment of the component according to the present disclosure the heat shield and the covering element are made from the same material.

An embodiment of the motor vehicle according to the present disclosure relates to a motor vehicle having a component of the type according to the present disclosure described previously.

In a preferred embodiment of the motor vehicle according to the present disclosure, the component described in the preceding text is arranged between a heat source or a heat conductor and the plastic part in the motor vehicle, serving as a heat shield arrangement, wherein the component is particularly preferably arranged in the engine compartment of the motor vehicle.

The following includes a brief description of a manufacturing process that may be used advantageously to produce the component according to the present disclosure, and which in the opinion of the Applicant is also of an inventive nature. An embodiment of the manufacturing process for manufacturing the component is as follows. A plastic part is prepared with a projection and a heat shield is prepared with a hole. The projection is inserted through the hole in the heat shield. The projection is reshaped to form a rivet connection with a rivet head that secures the heat shield in place. A covering element may be fastened to a protruding attachment provided on the rivet head.

Regarding further advantageous embodiments of such a manufacturing process, reference is herewith made to the embodiments of the component according to the present disclosure, the features of which could easily be applied to the process by a person skilled in the art.

### BRIEF DESCRIPTION OF THE DRAWINGS

The present disclosure will hereinafter be described in conjunction with the following drawing figures, wherein like numerals denote like elements.

FIG. 1 is a cross sectional view illustrating the process for manufacturing an embodiment of the component according to the present disclosure as shown in FIG. 3:

FIG. 2 is a further cross sectional view illustrating the process for manufacturing an embodiment of the component according to the present disclosure as shown in FIG. 3; and

FIG. 3 is a cross sectional view of an embodiment of the component according to the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

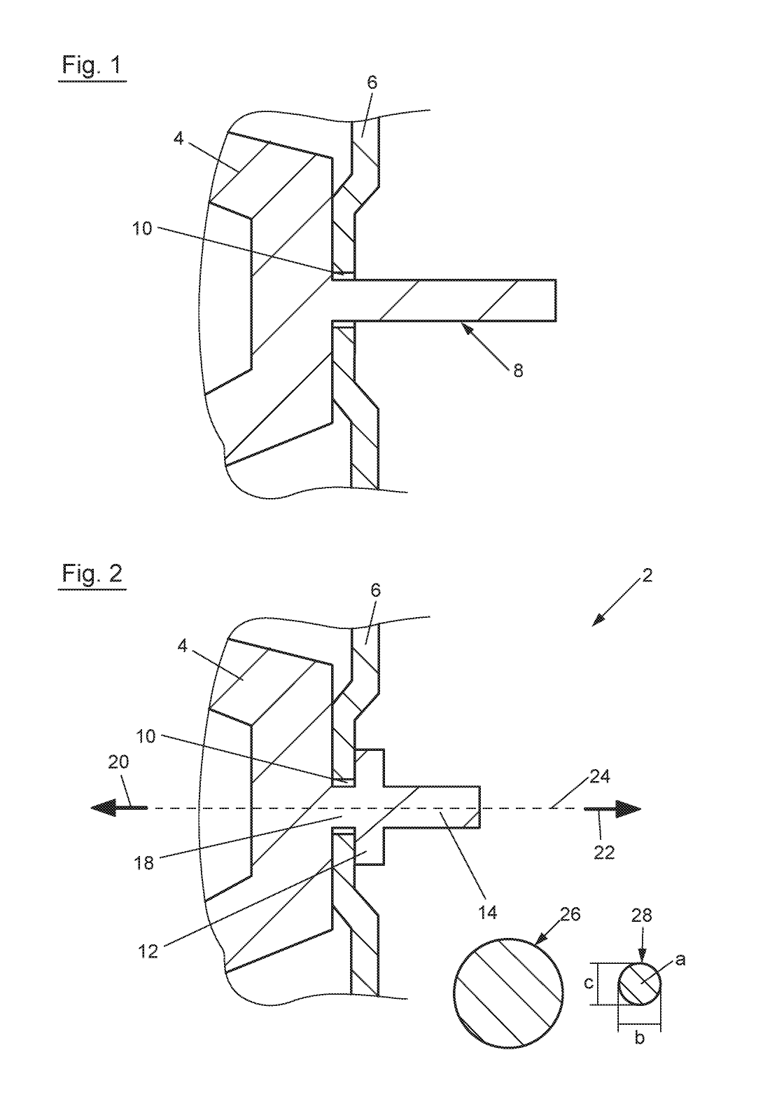

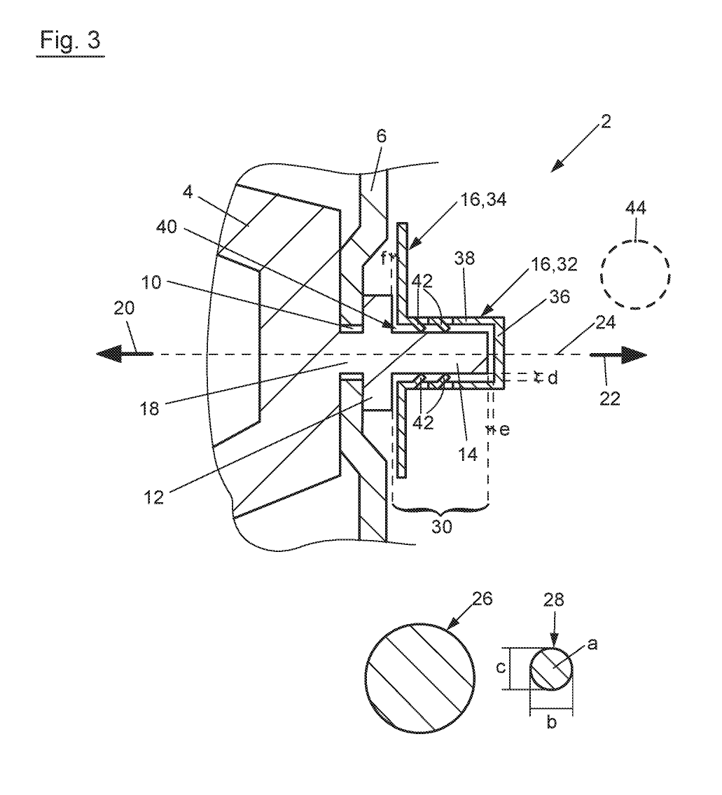

FIG. 3 shows an embodiment of the component 2 according to the present disclosure for a motor vehicle. An embodiment of a process for manufacturing component 2 will be described in the following, initially with reference to FIGS. 1 to 3.

A plastic part 4, which may be for example a valve cover in a motor vehicle, and a heat shield 6 are prepared in a process step. A projection 8, which in the present embodiment is substantially pin-shaped, is provided on plastic part 4 and conformed integrally with plastic part 4. On the other hand a hole 10 is formed in heat shield 6. As is shown in FIG. 1, projection 8 is pushed through hole 10 until heat shield 6 reaches a reference position on plastic part 4 as indicated in FIG. 1. Then—as indicated in FIG. 2—the end of projection 8 that protrudes through hole 10 is reshaped to form a rivet connection with a rivet head 12 that hooks behind heat shield 6. A protruding attachment 14 is provided on rivet head 12. The reshaping may be carried out for example using a corresponding molded part (not shown) and by heating the projection 8. Then, a covering element 16 may be fastened to protruding attachment 14, to arrive at the embodiment of component 2 according to FIG. 3. In the following, the further features of component 2 will be explained, wherein it should be note that they are also to be understood as features of the previously described manufacturing process in corresponding manner.

Heat shield 6 and covering element 16 have greater thermal resistance, possibly also greater thermal conductivity than plastic part 4. Accordingly, heat shield 6 and covering element 16 are preferably manufactured from metal, optionally steel or aluminum. Thus, heat shield 6 and covering element 16 may also be described as a sheet metal part. At the same time, in principle heat shield 6 and covering element 16 may also be made from different materials. Although it is preferable that heat shield 6 and covering element 16 are made from the same material.

After the reshaping of projection 8, a section 18 thereof remains inside hole 10, such that section 18 extends correspondingly through hole 10. In FIG. 3, the opposite extension directions 20, 22 of this section 18 are indicated with appropriate arrows. Extension directions 20, 22 may also be referred to as the lengthwise directions. In extension direction 20, section 18 is followed by the aforementioned rivet head 12 of the rivet connection, which hooks behind the heat shield 6 and fastens to plastic part 4. Protruding attachment 14 is arranged on the side of rivet head 12 farthest from section 18 in extension direction 20. Protruding attachment 14 is also arranged so as to lie flush with section 18 in extension direction 20. More specifically, in the embodiment shown, section 18 and protruding attachment 14 have the same extension directions 20, 22 and, so section 18 and protruding attachment 14 in the embodiment shown are preferably arranged and extend along a common straight line 24 in extension directions 20, 22.

As is further indicated in FIG. 3, rivet head 12 and protruding attachment 14 each have a cross section 26 and 28. Cross section 28 of protruding attachment 14 has a smaller cross sectional area a and/or cross sectional width b and/or cross sectional height c than cross section 26 of rivet head 12. In the embodiment shown, cross section 28 of protruding attachment 14 is circular, but it is also possible for cross section 28 of protruding attachment 14 to be a different shape, for example polygonal. Cross section 26 of rivet head 12 is also circular in the embodiment shown, though in principle a different shape. e.g., a polygonal shape is possible here too.

Protruding attachment 14 has a uniform cross sectional area a, cross sectional shape, cross sectional width b and/or cross sectional height c in at least one extension section 30 thereof. In the embodiment shown for exemplary purposes, extension section 30 extends over the entire length of protruding attachment 14 in extension directions 20, 22. However, it should be noted that extension section 30 may also be shorter than the total length of protruding attachment 14 in extension directions 20, 22.

As was indicated previously, covering element 16 may be fastened to protruding attachment 14. The covering element 16 is preferably fastened to protruding attachment 14 in positive and/or force-fitting manner. Accordingly, covering element 16 has a fastening section 32 for fastening to protruding attachment 14 and a rim or covering section 34 for covering rivet head 12.

Fastening section 32 is essentially cup-shaped, and accordingly has a cupped bottom 36 and a surrounding, preferably enclosing sidewall 38. On the other hand, an opening 40 is conformed on the side opposite cupped bottom 36, and faces in extension direction 22. Accordingly, protruding attachment 14 is insertable or inserted in cup-shaped fastening section 32 in the frame of the fastening of covering element 16 via opening 40. On the other hand, covering section 34 is substantially disc-shaped, preferably annular. In this context, covering section 34 surrounds fastening section 32 in enclosing manner, and in the embodiment shown covering section 34 surrounds and encloses fastening section 32 in the area of opening 40. However, it should be noted that covering section 34 might also surround and enclose fastening section 32 in the area of cupped bottom 36 or elsewhere. Regardless of the respective arrangement of covering section 34 the specific shape thereof, when covering element 16 is in the fastened state with protruding attachment 14, covering section 34 is arranged relative to rivet head 12 in such manner that it completely covers rivet head 12 when viewed in extension direction 22 of protruding attachment 14, as is made evident particularly in FIG. 3. Cupped bottom 36 also covers protruding attachment 14 completely when viewed in extension direction 20.

In summary, it should therefore first be noted that covering element 16 can be assembled with protruding attachment 14 to create a positive and/or force-fitting connection, and for this purpose covering element 16 with its fastening section 32 can be fitted on protruding attachment 14 in extension direction 22 of protruding attachment 14. In order to create the positive and/or form-fitting connection with fastening section 32 on protruding attachment 14, fastening section 32 has at least one, in this case several fastening projections 42. Fastening projections 42 are provided on sidewall 38 of cup-shaped fastening section 32 and/or at least partly formed by sidewall 38. Fastening projections 42, of which preferably at least three are distributed around the circumference of sidewall 38, may be for example fastening projections 42 that indent or cut into protruding attachment 14 when fastening section 32 to protruding attachment 14, in order to create a positive fit fastening, so that covering element 16 is fixed on protruding attachment 14 in extension direction 20, preferably also in extension direction 22. Alternatively or in addition thereto, fastening projections 42 may also be conformed in such manner that they are or can be preloaded against protruding attachment 14 transversely to extension direction 20, 22 of protruding attachment 14 when covering element 16 is fastened to or fitted on protruding attachment 14. Accordingly, in the embodiment shown, fastening projections 42 are in the form of fastening tabs for exemplary purposes, and were stamped out of sidewall 38, and fastening projections 42 may also be projections on the in-side of sidewall 38, in order to prevent sidewall 38 from being broken through.

Regardless of the respective design of the fastening projections 42, they can be or are connected to protruding attachment 14 while preserving a distance between the rest of fastening section 32, preferably at least sidewall 38, optionally also cupped bottom 36, and protruding attachment 14, as is indicated in FIG. 3 by distance d from sidewall 38 and distance e from cupped bottom 36. Covering element 16 is also fastenable or fastened to protruding attachment 14 while preserving a distance between said element, preferably while preserving a distance between covering section 34 of covering element 16 and rivet head 12, as is indicated in FIG. 3 by distance f.

The component 2 shown in FIG. 3 is preferably installed in a motor vehicle. For example, plastic part 4 may be a valve cover. In this context, component 2 is arranged in the motor vehicle, preferably in the engine compartment of the motor vehicle, in such a manner that the heat shield 6 and the covering element 16 is arranged between a heat source or a heat conductor 44 (shown schematically in FIG. 3) and plastic part 4. Accordingly, heat source or a heat conductor 44 may be for example an exhaust pipe, an engine block or similar components.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-13. (canceled)

14. A component for a motor vehicle comprising a plastic part and a heat shield fastened to the plastic part, the plastic part having a projection extending into a hole formed through the heat shield and reshaped to form a rivet connection having a rivet heat that secures the heat shield to the plastic part and a protruding attachment provided on the rivet head for fastening a covering element.

15. The component according to claim 14, wherein the covering element is fastened to the protruding attachment in a force-fitting manner.

16. The component according to claim 15, wherein the covering element is configured to be assembled on the protruding attachment with the creation of a positive connection.

17. The component according to claim 15, wherein the covering element comprises a fastening section for fastening with the protruding attachment and a covering section for covering the rivet head, which is covered by the covering section in the extension direction of the protruding attachment.

18. The component according to claim 17, wherein the fastening section comprises a cup, wherein the protruding attachment is accommodated in the cup-shaped fastening section.

19. The component according to claim 17, wherein the covering section comprises a disc-shaped element, which surrounds the fastening section.

20. The component according to claim 17, wherein the fastening section comprises at least one fastening projection that indents into the protruding attachment and is preloaded against the protruding attachment, wherein the at least one fastening projection is connected to the protruding attachment, while preserving a distance between the remaining the fastening sections and the protruding attachment.

21. The component according to claim 17, wherein the covering element is fastened to the protruding attachment while maintaining a distance from the covering element.

22. The component according to claim 21 wherein the covering element is fastened to the protruding element while preserving a distance between the covering section of the covering element and the rivet head.

23. The component according to claim 16, wherein the protruding attachment is arranged on the side of the rivet head facing away from a section of the projection that extends through the hole, wherein the section and protruding attachment have the same extension direction.

24. The component according to claim 23, wherein the protruding attachment is aligned flush with the section in extension direction of the section.

25. The component according to claim 16, wherein the protruding attachment comprises a cross sectional area, a cross sectional width, and a cross sectional height that are smaller than a cross sectional area, a cross sectional width, and a cross sectional height of the rivet head.

26. The component according to claim 25, wherein the protruding attachment comprises a uniform cross sectional area, cross sectional shape, cross sectional width or cross sectional height in at least one extension section thereof.

27. The component according to claim 26, wherein the cross section of the protruding attachment is circular or polygonal in shape.

28. The component according to claim 25, wherein the protruding attachment is produced by reshaping the projection.

29. The component according to claim 16, wherein at least one of the heat shield and the covering element has greater thermal resistance or thermal conductivity than the plastic part.

30. The component according to claim 29, wherein at least one of the heat shield and the covering element is made from metal.

31. The component according to claim 29, wherein the heat shield and the covering element are made from the same material.

32. A motor vehicle having a component according to claim 16, wherein the component is arranged between a heat source and the plastic part in the motor vehicle.

33. The motor vehicle according to claim 32, wherein the component is arranged in the engine compartment of the motor vehicle, thereby forming the heat shield arrangement.
